(19) United States
(12) Patent Application Publication
(10) Pub. No.: US 2025/0033894 A1
(43) Pub. Date: Jan. 30, 2025

(54) CONVEYOR BELT CLEANING APPARATUS

(71) Applicant: Australian Conveyor Components Pty Ltd, Maleny (AU)

(72) Inventors: Lawrence Harvey Robinson, Maleny (AU); Aaron Parker, Maleny (AU)

(21) Appl. No.: 18/707,228

(22) PCT Filed: Nov. 3, 2022
(86) PCT No.: PCT/AU2022/051319

§ 371 Date: May 3, 2024

(30) Foreign Application Priority Data
Nov. 3, 2021 (AU) 2021903516

(51) Int. Cl. B65G 45/16

(52) U.S. Cl. CPC B65G 45/16

(57) ABSTRACT

A conveyor belt cleaning apparatus for scraping a conveyor belt comprises a scraping plate comprising a tip configured to contact and scrape the conveyor belt, an attachment portion for attaching the cleaning apparatus to a base and detaching the cleaning apparatus from the base and a body connecting the scraping plate and the attachment portion. The attachment portion comprises a fastener and the fastener is the only accessible means for detachment of the cleaning apparatus from the base or disassembly of the apparatus.

### FIELD OF THE INVENTION

The invention relates to a conveyor belt cleaning apparatus. In particular, the invention relates, but is not limited, to a conveyor belt cleaning apparatus configured to scrape debris and the like from a conveyor belt.

### BACKGROUND TO THE INVENTION

Reference to background art herein is not to be construed as an admission that such art constitutes common general knowledge in Australia or elsewhere.

Conveyor belt cleaners are used to remove unwanted material from conveyor belts. Such unwanted material may be residual material carried on, or stuck to, the belt after the bulk of material is discharged from the belt at a main discharge. For instance, coal particles and/or coal slurry may stick to conveyor belts after crushed coal is discharged from the belt. In order to remove the residual material from the conveyor belt, a conveyor belt cleaner or scraper may be used.

A conventional conveyor belt cleaner includes an elongate base or rail extending transversely across the width of the conveyor belt and a plurality of cleaning blades, scrapers, or similar apparatus mounted to the base or rail. The cleaning blades or scrapers are fixed in position relative to the direction of travel of the conveyor belt and force is applied to the elongate rail to bias the cleaning blades or scrapers against the conveyor belt. Accordingly, as the conveyor belt moves past the cleaning blades or scrapers, the residual material carried by the conveyor belt is removed by the blades or scrapers. However, as the conveyor belt, scrapers and blades wear, a greater force must be applied to the base or rail to make the blades or scrapers contact the conveyor belt.

The cleaning blades or scrapers used in a conventional conveyor belt cleaner are rigidly attached to the base or rail and as the conveyor belt scrapers and blades wear, often unevenly due to the centre of the belt seeing more traffic, the conveyor belt cleaner loses efficiency. Additionally, as the belt wears, the cleaner may apply significantly different scraping profiles at each individual cleaning blade or scraper, leading to further uneven wear, or further loss of efficiency in cleaning.

Conventional conveyor belt cleaners have several components that are removably attached through several attachment points to allow for maintenance and replacement. These attachment points can lead to weakness of the conveyor belt cleaner if their associated fasteners are not correctly installed or reinstalled after maintenance. This type of incorrectly installed fastener can lead to significant or even catastrophic belt damage. The multiple attachment points can also lead to confusion and inefficiency during maintenance as it is not always clear which attachment points should be removed to maintain a particular part.

Thus, there is a need to provide a conveyor belt cleaning apparatus that can effectively deal with variations in wear of the conveyor belt, and/or provide efficient cleaning, whilst also minimising further damage to the belt caused by cleaning blades or scrapers contacting the conveyor belt, and/or provide a simplified method of maintenance to address one or more of the aforementioned problems.

### OBJECT OF THE INVENTION

It is a preferred object of this invention to provide a conveyor belt cleaning apparatus which overcomes or at least ameliorates one or more of the aforementioned disadvantages or problems with cleaning a conveyor belt or maintaining a conveyor belt cleaning apparatus, and/or which at least provides a useful commercial alternative.

Other preferred objects of the present invention will become apparent from the following description.

### SUMMARY OF INVENTION

Generally, the present invention is directed to a conveyor belt cleaning apparatus, components of such a cleaning apparatus and a conveyor belt cleaning system.

In one form, but not necessarily the broadest form, the invention resides in a conveyor belt cleaning apparatus for scraping a conveyor belt, the apparatus comprising:
a scraping plate comprising a tip configured to contact and scrape the conveyor belt;
an attachment portion for attaching the cleaning apparatus to a base and detaching the cleaning apparatus from the base, the attachment portion comprising a fastener; and,
a body connecting the scraping plate and the attachment portion;
wherein the fastener is the only accessible means for detachment of the cleaning apparatus from the base or for disassembly of the apparatus.

Preferably, the attachment portion comprises a boss configured to allow rotational movement of the cleaning apparatus in relation to the base. Preferably, the attachment portion comprises a single boss.

Preferably, the body comprises a rigid insert or element with a first surface and a second surface angled relative to each other, wherein the first surface is attached to the attachment portion and the second surface is substantially aligned with the scraping plate. Preferably, the body provides an offset between the second surface of the rigid insert and the scraping plate.

Suitably, the volume between the first surface and the second surface of the rigid insert comprises resilient flexible material.

In another embodiment of the invention, the volume between the first surface and the second surface of the rigid insert is solid or filled and comprises steel or another stiff material.

Preferably, the body further comprises a resilient flexible material, in particular between the scraping plate and the rigid insert to allow relative movement between the scraping plate and the attachment portion.

Preferably, when in use, the combination of rotational movement allowed by the boss and deformation of the body under tension results in the tip being in contact, and parallel with a surface of the conveyor belt.

Preferably, the boss is configured to lock into a sleeve of the base. Preferably, the length of the boss is selected such that, in use, the conveyor belt cleaning apparatus does not contact an adjacent conveyor belt cleaning apparatus.

In another embodiment of the invention, the sleeve is selected such that, in use, the conveyor belt cleaning apparatus does not contact adjacent conveyor belt cleaning apparatus.

Preferably, the resilient flexible material is polyurethane.

In another embodiment, the resilient flexible material is rubber.

Preferably, the tip is angled relative to the scraper plate such that the angle between the tip and the attachment portion is about 90 degrees.

Preferably, the tip is elongate and can be of unitary construction or can comprise a plurality of segments.

The conveyor belt cleaning apparatus may be of any suitable size. Preferably, the conveyor belt cleaning apparatus is of sufficient size and configuration to remove unwanted material from a conveyor belt. However, it will be understood that the size and configuration of the conveyor belt cleaning apparatus may vary depending on a number of factors, such as the size and type of conveyor belt to be cleaned, the type of material to be removed from the conveyor belt and/or the amount of space available. In use, it is envisaged that a plurality of conveyor belt cleaning apparatus can be used in cooperation to remove material from a conveyor belt.

Preferably, a plurality of conveyor belt cleaning apparatus used in cooperation are of sufficient length that to extend across at least the width of the conveyor belt. Preferably, the plurality of conveyor belt cleaning apparatus extends beyond the lateral sides of the conveyor belt to ensure 100% cleaning coverage.

The conveyor belt cleaning apparatus may be located in any suitable position with access to the surface of the conveyor belt. For instance, the conveyor belt cleaning apparatus may be positioned under the return side of a conveyor belt, above the conveyor belt, or at an end of a conveyor belt. Preferably, the conveyor belt cleaning apparatus is positioned under the return side of a conveyor belt.

Preferably, the conveyor belt cleaning apparatus is associated with a base member. A single base member may be associated with each of a plurality of cleaning apparatus, or there may be a base member associated with each apparatus, or a base member associated with several, but not all, apparatus in a single location on the conveyor belt.

In another form, the invention resides in a conveyor belt cleaning system for scraping a conveyor belt, the system comprising one or more conveyor belt cleaning apparatus mounted to one or more base members, wherein at least one of the conveyor belt cleaning apparatus comprises:
a scraping plate comprising a tip configured to contact and scrape the conveyor belt;
an attachment portion for attaching the cleaning apparatus to a base and detaching the cleaning apparatus from the base, the attachment portion comprising a fastener; and,
a body connecting the scraping plate and the attachment portion;
wherein the fastener is the only accessible means for detachment of the cleaning apparatus from the base or for disassembly of the apparatus.

In further form, the invention resides in a conveyor belt cleaning apparatus, the apparatus comprising a tip and an attachment portion, wherein, in use, the tip and the attachment portion are at an angle to each other of about 90 degrees; and wherein the tip and the attachment portion are connected by at least one deformable member.

In a yet further form, the invention resides in a conveyor belt cleaning apparatus for cleaning a conveyor belt, the apparatus comprising a tip configured to contact the conveyor belt at about 90 degrees, wherein the tip is connected to an attachment portion by a deformable body, and wherein the attachment portion is attached to a base that provides upward force to the conveyor belt cleaning apparatus that is transferred through the tip to the conveyor belt at about 90 degrees to the conveyor belt.

Further features and advantages of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is a perspective view of a conveyor belt cleaning apparatus, according to an embodiment of the invention;

FIG. 2 is a side view of the cleaning apparatus shown in FIG. 1 with some internal features illustrated in broken lines;

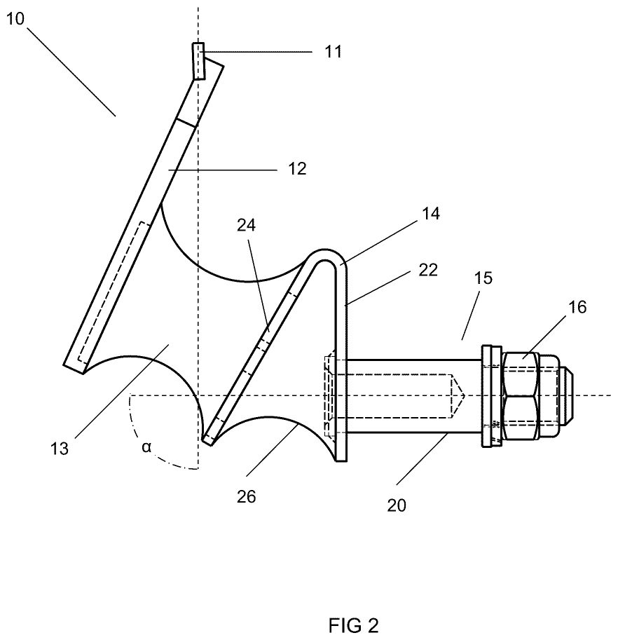

FIG. 3 is a perspective view of a scraper plate of the cleaning apparatus shown in FIG. 1 without a tip attached thereto;

FIG. 4 is a perspective view of a rigid insert and attachment portion of the cleaning apparatus shown in FIG. 1;

FIG. 5 is an exploded view of the cleaning apparatus shown in FIG. 1, and a base of a conveyor belt cleaning system to which the cleaning apparatus is attached;

FIG. 6 is a perspective view of a conveyor belt cleaning system according to an embodiment of the invention comprising a plurality of the cleaning apparatus shown in FIG. 1 in an offset arrangement; and

FIG. 7 is a schematic plan view of the offset arrangement of the plurality of the conveyor belt cleaning apparatus in the conveyor belt cleaning system according to an embodiment of the invention.

Skilled addressees will appreciate that elements in the drawings are illustrated for simplicity and clarity and have not necessarily been drawn to scale. For example, the relative dimensions of some elements in the drawings may be distorted to help improve understanding of embodiments of the present invention.

### DETAILED DESCRIPTION OF THE DRAWINGS

One example of a conveyor belt cleaning system that can be used to clean a conveyor belt is described in the Applicant's earlier International Patent Application No. PCT/AU2021/050003, which is incorporated herein by reference. At least some embodiments of the present invention described herein represent improvements to certain aspects of the conveyor belt cleaning system described in PCT/AU2021/050003.

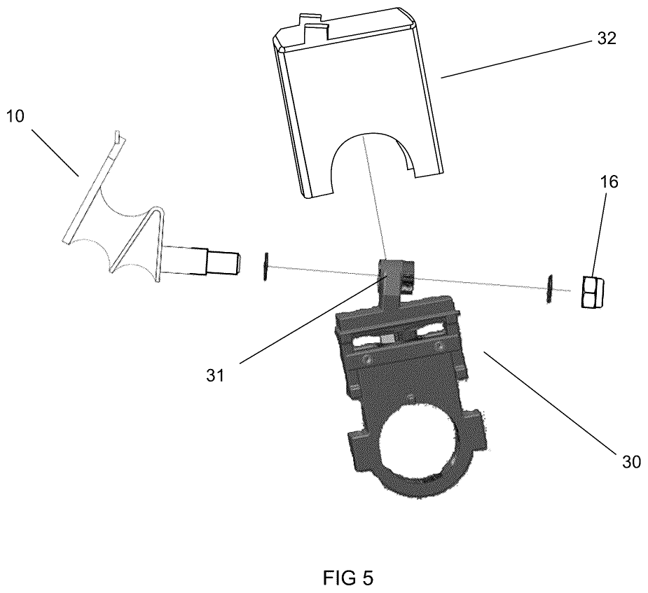

Referring to the figures herein, a preferred embodiment of the present invention in the form of a conveyor belt cleaning apparatus (10) comprises a scraping plate (12) comprising a tip (11) configured to contact and scrape a conveyor belt (not shown). The conveyor belt cleaning apparatus comprises an attachment portion (15) for attaching the cleaning apparatus to a base (30) of a conveyor belt cleaning system which is at least partially protected by a cover (32) as shown in FIG. 5. The conveyor belt cleaning apparatus further comprises a body connecting the scraping plate (12) and the attachment portion (15). In some embodiments, the body comprises a resilient flexible material (13), a rigid insert or element (14) and a resilient flexible material (26), as described in further detail herein.

The base (30) may be of any suitable shape and one embodiment is shown in FIG. 5. Further shapes such as those constructed from RHS steel, or aluminium are also envisaged, such as a square section.

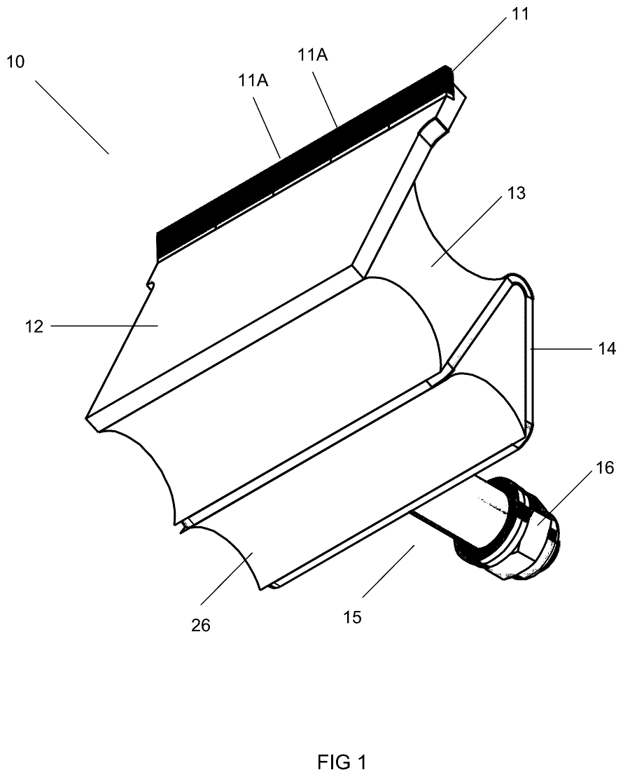

The tip (11) may be of unitary construction or comprise a plurality of adjacent tip sections (11A) to span the width of the scraping plate (12), as shown in FIG. 1.

The attachment portion (15) comprises a boss (20) configured to allow rotational movement of the cleaning apparatus (10) in relation to the base (30). In preferred embodiments, the attachment portion comprises a single boss (20).

The body of the cleaning apparatus (10) comprises a rigid insert or element (14) having a first surface (22) and a second surface (24) angled relative to each other. The first surface (22) is attached to the attachment portion (15) and the second surface (24) is substantially aligned with the scraping plate (12). This arrangement provides an offset or displacement between the second surface (24) of the rigid insert (14) and the scraping plate (12).

In some embodiments, the volume between the first surface (22) and the second surface (24) of the rigid insert (14) comprises resilient flexible material (26), as shown in the accompanying figures.

In another embodiment of the invention, the volume between the first surface (22) and the second surface (24) of the rigid insert (14) is solid or filled and comprises steel or another stiff material.

The body further comprises a resilient flexible material (13), in particular between the scraping plate (12) and the rigid insert (14) to allow relative movement between the scraping plate (12) and the attachment portion (15).

Hence, connection of the scraping plate (12) to the attachment portion (15) is achieved using resilient material bonded into both the scraping plate (12) and the rigid insert (14) to which the attachment portion (15) is coupled. Connection of the scraping plate (12) to the attachment portion (15) is thus achieved without the use of removable fasteners. This connection provides several advantages, namely reducing the number of parts required for manufacture, and exposing only a single fastener—nut (16)—to harsh environmental conditions. Furthermore, there is only a single point for removal of the apparatus, thus reducing complexity, the likelihood of errors and the time taken during maintenance and replacement.

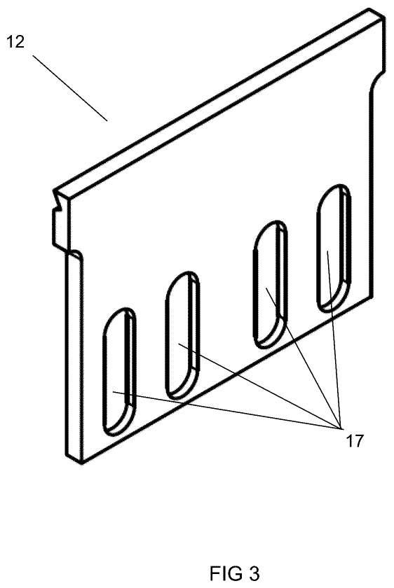

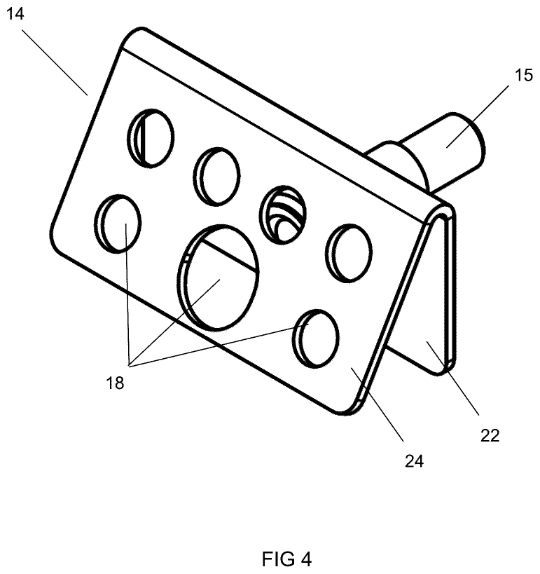

With particular reference to FIGS. 3 and 4, holes (18) and grooves (17) are provided on the rigid insert (14) and scraper plate (12) respectively to strengthen the bond between the resilient material and the rigid insert and scraper plate and to reduce the mass of the scraper plate. As a person skilled in the art would appreciate, the bonding of the resilient material to the scraper plate (12) and the rigid insert (14) can be achieved in a conventional manner by any suitable means known in the art and, ideally, is performed to avoid or minimize the formation of shear points.

The conveyor cleaning apparatus (10) cleans a conveyor belt through the tip (11) of the scraping plate (12) being pressed against the surface of a conveyor belt such that any material attached to the conveyor belt is scraped away, following the surface of the scraping plate to be discarded or further processed. The scraping plate (12) provides a predominantly planar surface to direct any scraped material away from the conveyor belt. The tip (11) is angled relative to the planar surface of the scraping plate (12), as shown in this embodiment, at about 25 degrees. This angle is selected such that the angle (α) between the tip (11) and the attachment portion (15) is about 90 degrees, and so in use the angle of the tip (11) relative to the conveyor belt is about 90 degrees. This angle may be varied based on operating parameters of the conveyor belt, such as the type of material required to be cleaned, the material from which the conveyor belt is constructed, and a level of moisture in the material on the conveyor. Typically, this angle is selected to be between about 15 degrees and about 90 degrees, although other angles may be desirable depending on the particular conveyor belt.

The tip (11) is biased against the conveyor belt with a force provided by the base (30), and in use, the resilient portion (13) of the body provides yielding support to the scraping plate (12), such that the scraping plate tip (11) can conform to minor irregularities and movement in the conveyor belt. In the preferred embodiment shown, the portion of the body comprising the rigid insert or element (14) additionally provides yielding support to the scraping plate (12), with the volume between the first and second surfaces (22, 24) of the rigid insert being filled with resilient material. It is envisaged that this volume could alternatively be filled with a solid material such as steel or another solid and rigid material depending on the stiffness requirements of the apparatus.

In the preferred embodiment shown, the attachment portion (15) is a singular boss (20) that is configured to be attached to the sleeve (31) of a base (30) and fastened in position by the fastener (16). This arrangement allows the apparatus to rotate relative to the base (30) about a longitudinal axis defined by the boss (20). Any suitable fastener may be used to fasten the boss (20) of the attachment portion (15) to the base (30), provided the rotational functionality is maintained. The rotation of the apparatus (10) relative to the base (30) allows the tip (11) to maintain efficient contact with the conveyor belt. The combination of this rotation and the abovementioned yielding support provided by the resilient portions (13, 26) of the body allows the tip to remain in controlled contact, and parallel with a surface of the conveyor belt along the length of the tip (11), in addition to the tip (11) remaining substantially at the selected attack angle with the conveyor belt—typically 90 degrees. This provides an advantage in efficiency of cleaning, even when the belt is worn or damaged, and additionally introduces less wear to the conveyor belt than would be caused by conventional apparatus under constant tension.

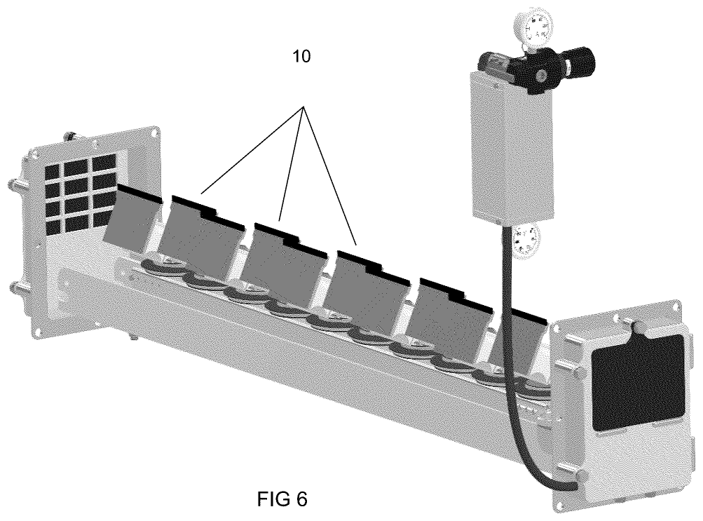

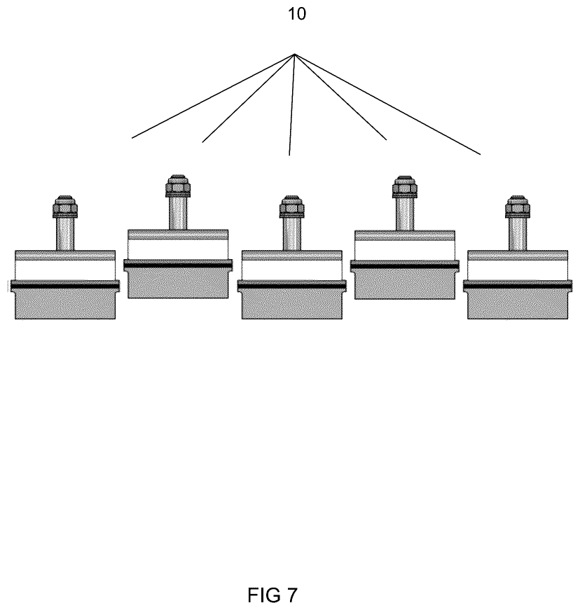

In use, a plurality of the conveyor belt cleaning apparatus (10) are used in cooperation to span the width of a conveyor belt. In a preferred embodiment, the length of the boss of the attachment portion (15) is selected to allow for adjacent cleaning apparatus to rotate about the attachment portion (15) without contacting adjacent cleaning apparatus (10). For instance, with reference to FIGS. 6 and 7, in a preferred embodiment, cleaning apparatus (10) in a cooperating set alternate between bosses of the attachment portion (15) having long and short lengths so that the tips (11) of each are offset and cannot collide. This prevents the tips from becoming damaged or prematurely worn. In an alternative embodiment, this is achieved through the selection of bases (30) such that the sleeves (31) that cooperate with the attachment portions (15) are similarly alternating in length. Further embodiments where the bases (30) are offset in an alternating or cascading manner, or any configuration which prevents collision, are also considered, such as in the system illustrated in FIGS. 6 and 7.

In this specification, adjectives such as first and second, forward and backward, upward and downward, upper and lower, top and bottom and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A conveyor belt cleaning apparatus for scraping a conveyor belt, the apparatus comprising:
a scraping plate comprising a tip configured to contact and scrape the conveyor belt;
an attachment portion for attaching the cleaning apparatus to a base and detaching the cleaning apparatus from the base, the attachment portion comprising a fastener; and
a body connecting the scraping plate and the attachment portion;
wherein the fastener is the only accessible means for detachment of the cleaning apparatus from the base or disassembly of the apparatus.

2. The conveyor belt cleaning apparatus of claim 1, wherein the attachment portion comprises a boss configured to allow rotational movement of the cleaning apparatus in relation to the base.

3. The conveyor belt cleaning apparatus of claim 2, wherein the attachment portion comprises a single boss.

4. The conveyor belt cleaning apparatus of claim 1, wherein the body comprises a rigid insert or element having a first surface and a second surface angled relative to each other, wherein the first surface is attached to the attachment portion and the second surface is substantially aligned with the scraping plate.

5. The conveyor belt cleaning apparatus of claim 4, wherein the body provides an offset between the second surface of the rigid insert and the scraping plate.

6. The conveyor belt cleaning apparatus of claim 4, wherein the volume between the first surface and the second surface of the rigid insert comprises a resilient flexible material.

7. The conveyor belt cleaning apparatus of claim 4, wherein a volume between the first surface and the second surface of the rigid insert is solid or filled and optionally comprises steel.

8. The conveyor belt cleaning apparatus of claim 1, wherein the body further comprises a resilient flexible material between the scraping plate and the attachment portion to allow relative movement between the scraping plate and the attachment portion.

9. The conveyor belt cleaning apparatus of claim 4, wherein, in use, the combination of rotational movement allowed by the boss and deformation of the body under tension results in the tip being in contact, and parallel with a surface of the conveyor belt.

10. The conveyor belt cleaning apparatus of claim 1, wherein the attachment portion is configured to lock into a sleeve of the base.

11. The conveyor belt cleaning apparatus of claim 1,
wherein the length of the attachment portion is selected, and/or each base is offset in an alternating or cascading manner, such that, in use, the conveyor belt cleaning apparatus does not contact an adjacent conveyor belt cleaning apparatus.

12. The conveyor belt cleaning apparatus of claim 10, wherein the sleeve is selected such that, in use, the conveyor belt cleaning apparatus does not contact an adjacent conveyor belt cleaning apparatus.

13. The conveyor belt cleaning apparatus of claim 6, wherein the resilient flexible material is polyurethane.

14. The conveyor belt cleaning apparatus of claim 6, wherein the resilient flexible material is rubber.

15. The conveyor belt cleaning apparatus of any preceding claim 1, wherein the tip is angled relative to the scraper plate.

16. The conveyor belt cleaning apparatus of any preceding claim 1, wherein the angle between the tip and the attachment portion is about 90 degrees.

17. A conveyor belt cleaning system for scraping a conveyor belt, the system comprising:
one or more conveyor belt cleaning apparatus mounted to one or more base members,
wherein at least one of the conveyor belt cleaning apparatus comprises:
a scraping plate comprising a tip configured to contact and scrape the conveyor belt;
an attachment portion for attaching the cleaning apparatus to a base and detaching the cleaning apparatus from the base, the attachment portion comprising a fastener; and
a body connecting the scraping plate and the attachment portion;
wherein the fastener is the only accessible means for detachment of the cleaning apparatus from the base or for disassembly of the apparatus.

18. A conveyor belt cleaning system for scraping a conveyor belt, the system comprising a plurality of conveyor belt cleaning apparatus according to claim 1 mounted to one or more base members.

19. A conveyor belt cleaning apparatus, the apparatus comprising:
a tip and an attachment portion,
wherein, in use, the tip and the attachment portion are at an angle to each other of about 90 degrees; and
wherein the tip and the attachment portion are connected by at least one deformable member.

20. A conveyor belt cleaning apparatus for cleaning a conveyor belt, the apparatus comprising:
a tip configured to contact the conveyor belt at about 90 degrees,
wherein the tip is connected to an attachment portion by a deformable body, and
wherein the attachment portion is attached to a base that provides upward force to the conveyor belt cleaning apparatus that is transferred through the tip to the conveyor belt at about 90 degrees to the conveyor belt.
